(19) United States
(12) Patent Application Publication
(10) Pub. No.: US 2011/0142655 A1
(43) Pub. Date: Jun. 16, 2011

(54) Fan set for wind power generator

(75) Inventors: Shin-Hao Chen, Taichung City (TW); Tso-Cheng Hsiao, Taichung City (TW)

(73) Assignee: Hiwin Mikrosystem Corp.

(21) Appl. No.: 12/653,608

(22) Filed: Dec. 16, 2009

(51) Int. Cl. F03D 11/04

(52) U.S. Cl. 416/204 R

(57) ABSTRACT

A fan set for a wind power generator is disclosed. The fan set has fan blades that are able to rotate between 0 and 90 degrees with respect to a fan hub, so that each of the fan blades has a concentrated position and an expanded position.

### BACKGROUND OF THE INVENTION

1. Technical Field

The present invention relates to fan sets for wind power generators, and more particularly, to a fan set featuring for a plurality of fan blades that are retractable to be parallel to an axis of a fan hub and expandable to be perpendicular to the axis of the fan hub.

2. Description of Related Art

A known wind power generator basically includes a tower, a dynamotor mounted atop the tower, a fan hub assembled to a motor shaft of the dynamotor and a plurality of fan blades fixed to the fan hub.

One existing approach to fabrication of the conventional wind power generator is to first assemble the fan hub to the motor shaft, and then fix the dynamotor to the tower after the dynamotor is lifted to the top of the erected tower. The fan blades are lift to the altitude of the dynamotor and fixed to the fan hub one by one. The repeated lifting operation and high-altitude assembling process of the fan blades is difficult, time-consuming and dangerous to the related workers.

Another known approach to fabrication of the conventional wind power generator is to pre-assemble the fan blades and the fan hub, and then hoist the assembly of the fan blades and the fan hub to the altitude of the dynamotor for further fixing operation. Although this approach eliminates the need of repeated lifting operation for the fan blades, the fan blades extending outwards from the fan hub tend to sway in wind during the hoist, and bring additional difficulty as well as safety risk to the related workers.

### SUMMARY OF THE INVENTION

One objective of the present invention is to provide a fan set for a wind power generator, wherein the fan set, as compared with the prior art, simplifies the assembling operation of the wind power generator by eliminating repeated lifting operation, reducing the difficulty, safety risk as well as time-consumption of the assembling process.

Another objective of the present invention is to provide a fan set for a wind power generator, wherein the fan set is adaptive to a telescopic tower.

According to the present invention, a fan set has: a fan hub; a plurality of fixing seats fixed to the fan hub; and a plurality of fan blades each having a fastening portion assembled to one said fixing seat, wherein, each said fan blade has a concentrated position at which the fan blade is parallel to an axis of the fan hub and an expanded position at which the fan blade is perpendicular to the axis of the fan hub.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is an exploded view of a fan set of the present invention;

FIG. 2 is a partially enlarged view of FIG. 1 showing a fastening portion of a fan blade, a fixing seat and a fah hub;

FIG. 3 is a perspective view of the fan set of the present invention showing the fan blades concentrated;

FIG. 4 is a partially enlarged view of FIG. 3 showing the fastening portions of the fan blades, the fixing seat and the fan hub;

FIG. 5 is a perspective view of the fan set of the present invention showing the fan blades expanded; and

FIG. 6 is a partially enlarged view of FIG. 5 showing the fastening portions of the fan blades, the fixing seat and the fan hub.

### DETAILED DESCRIPTION OF THE INVENTION

While a preferred embodiment provided hereinafter for illustrating the concept of the present invention as described above, it is to be understood that the components of the embodiment shown in the accompanying drawings are depicted for the sake of easy explanation and need not to be made in scale. Besides, counterparts through the drawings are denoted by the same numerals.

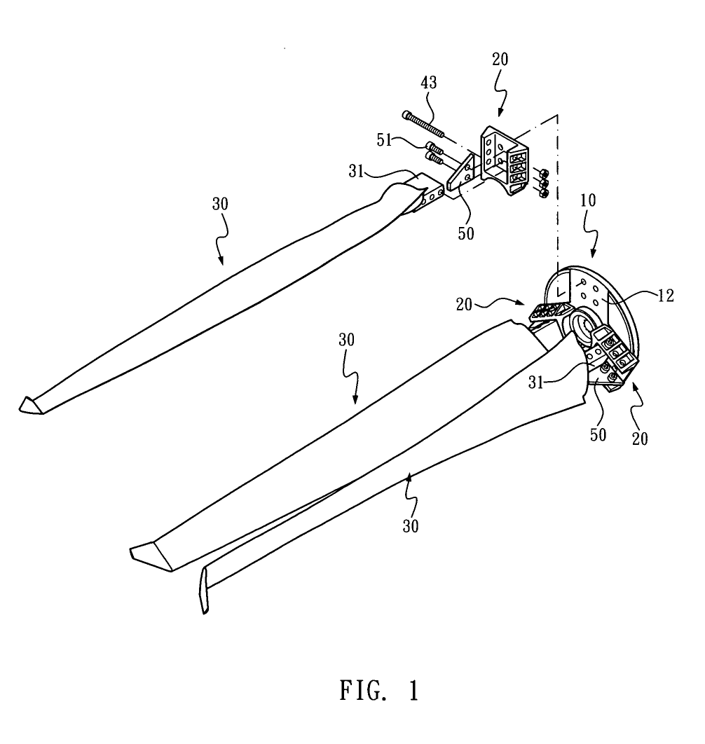

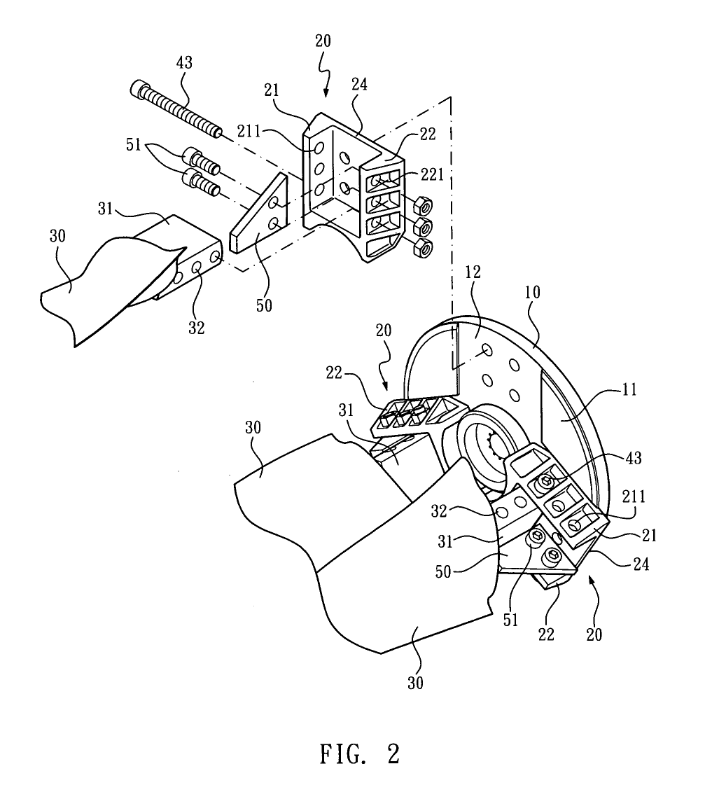

Referring to FIG. 1 and FIG. 2, a fan set of the present invention includes a fan hub 10, a plurality of fixing seats 20 fixed to the fan hub 10, and a plurality of fan blades 30 each having a fastening portion 31 fastened to the fixing seat 20.

The fixing seat 20 has a base 24. A first lateral wall 21 and a second lateral wall 22 facing each other across the fixing seat 20 while a third lateral wall 23 connects the first lateral wall 21 and the second lateral wall 22 at corresponding ends thereof. The first lateral wall 21 and the second lateral wall 22 are provided with a plurality of holes 211, 221 aligned to each other. The bases 24 of the fixing seats 20 are fixed to a front surface 11 of the fan hub 10 by means of screws. The front surface 11 of the fan hub 10 has positioning recesses 12 for receiving the base 24, so that when the bases 24 are fixed in the positioning recesses 12 by means of the screws, the fixing seats 20 can be firmly positioned relative to the fan hub 10.

Each said fan blade 30 has a fastening portion 31 shaped as a rectangular block. The fastening portion 31 includes a plurality of through holes 32 passing through its minor length. The fastening portion 31 is located between the first lateral wall 21 and the second lateral wall 22 with two sides thereof contacting the first lateral wall 21 and the second lateral wall 22, respectively. The plural through holes 32 of the fastening portion 31 and the plural holes 211, 221 of the first and second lateral walls 21, 22, when aligned, allow a plurality of bolts to pierce through and be positioned therein, so that the fastening portion 31 of the fan blade 30 can be received in the fixing seat 20.

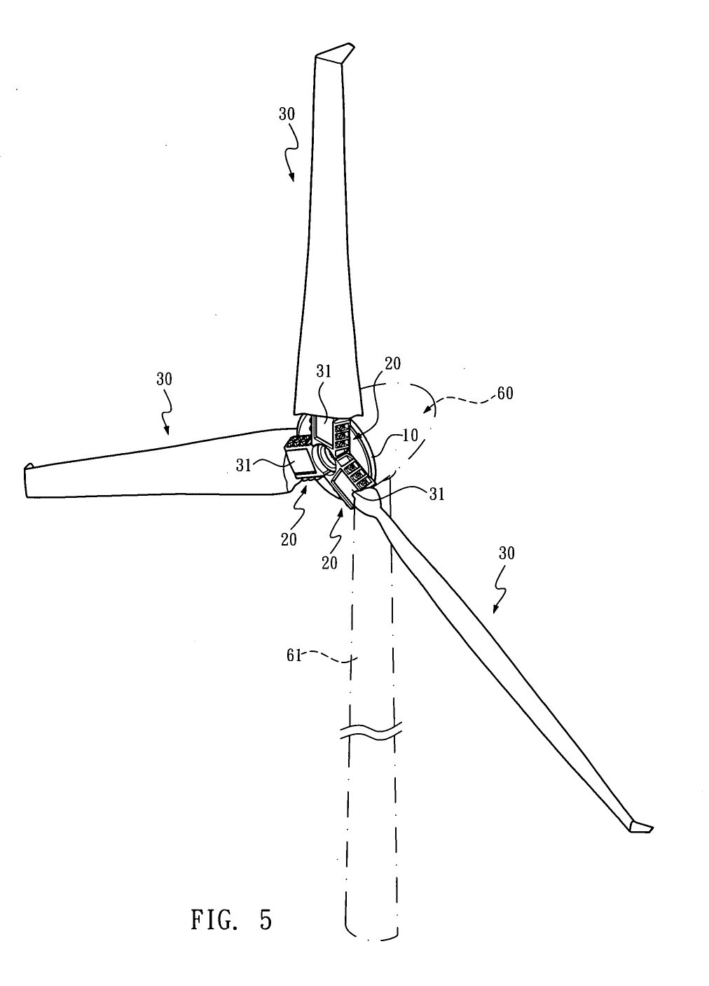

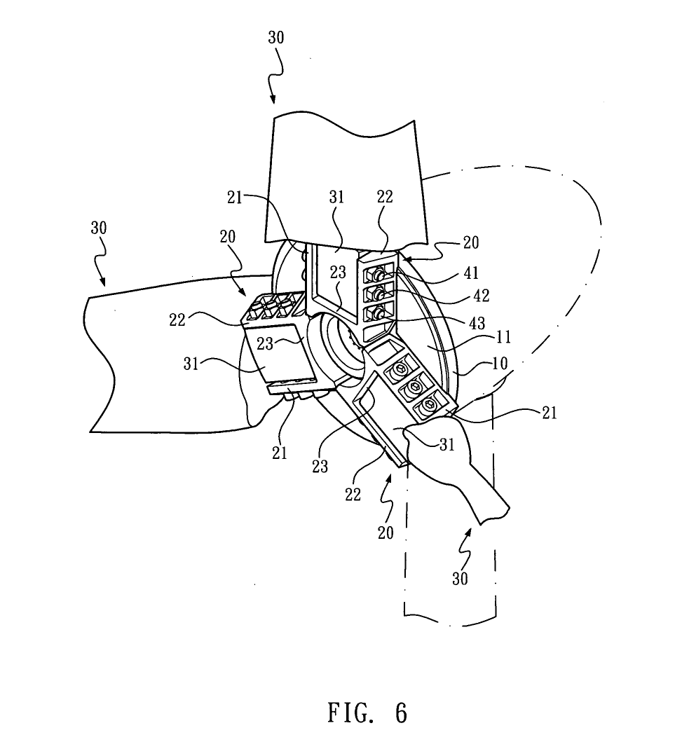

Since the holes 211, 221 of the first lateral wall 21 and the second lateral wall 22 are extended perpendicular to the axis of the fan hub 10, and the through holes 32 of the fastening portions 31 are extended parallel to the axis of the fan blades 30, when the through holes 32 of the fan blades 30 are aligned with the holes 211, 221 and passed by a plurality of bolts 41, 42, 43 (as shown in FIG. 6), the fan blades 30 are posed at an expanded position where they are perpendicular to the axis of the fan hub 10, as depicted in FIG. 5 and FIG. 6.

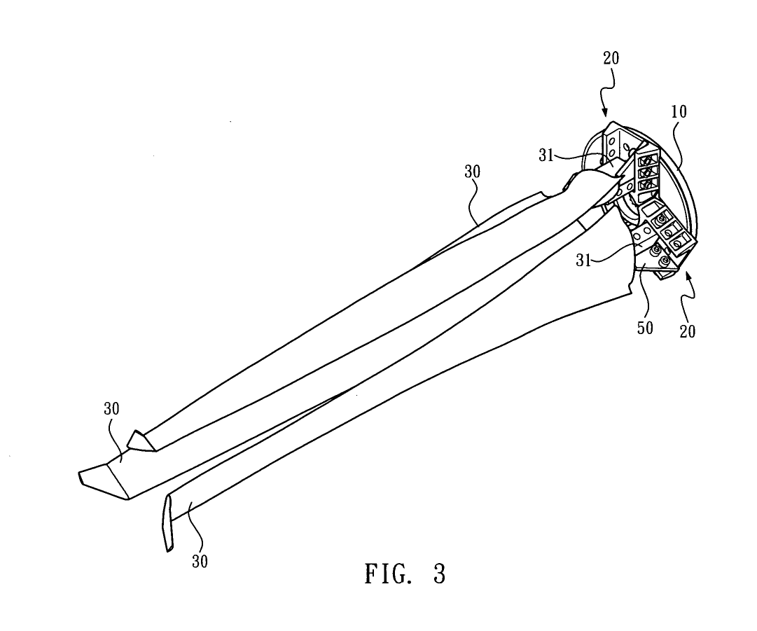

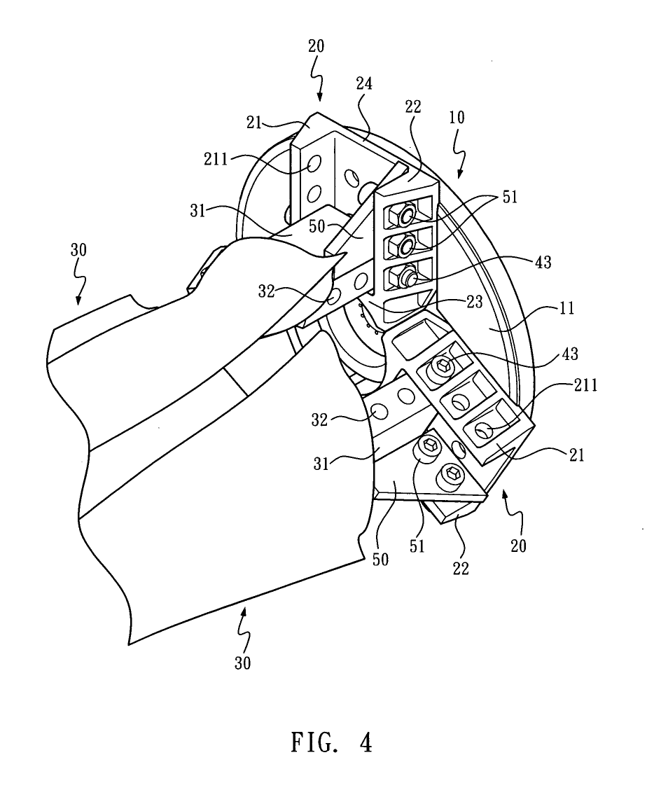

By removing the two bolts 41, 42 near the periphery of the fan hub 10 from the fixing seat 20, the fastening portion 31 is fixed to the fixing seat 20 by only one said bolt 43. At this time, the fan blade 30 is allowed to rotate in the fixing seat 20 against the bolt 43 between 0 and 90 degrees with respect to the axis of the fan hub 10. Particularly, when located at 0 degree with respect to the axis of the fan hub 10, the fan blades 30 are at the concentrated position parallel to the axis of the fan hub 10 with the fastening portions 31 of the fan blades 30 supported by the third lateral walls 23 of the fixing seats 20, and the fan blades 30 are retraced as shown in FIG. 3 and FIG. 4.

Referring back to FIG. 2, the retraced fan blades 30 are desired to be fixed temporarily so as not to sway or expand during transportation or hoist. In each said fixing seat 30, a removable retaining plate 50 is provided to retain the fastening portion of the corresponding fan blade 30 so as to prevent the fan blade 30 from rotating to a position at 90 degrees with respect to the axis of the fan hub 10. The retaining plate 50 abuts against the first lateral wall 21 or the second lateral wall 22 of the fixing seat 20, and uses the idle holes 211, 221 to receive screws 51. Before the fan blades 30 are expanded for normal operation, the retaining plates 50 are removed for allowing the fan blades 30 to be expanded as shown in FIG. 5.

The disclosed fan set allows the fan blades 30 to be retracted and parallel to the axis of the fan hub 10 or expanded and perpendicular to the axis of the fan hub 10. By such a novel design, a worker may pre-assemble the fan blades 30, the fan hub 10 and the dynamotor 60 (as shown in FIG. 5) on the ground, and retract the plurality of fan blades 30 before hoist the assembly of the three up to the top of the tower 61 (as shown in FIG. 5) and fix the dynamotor 60 to the tower 61. After this, the retaining plates 50 can be detached one by one, so that the fan blades 30 can be expanded to the position at 90 degrees with respect to the axis of the fan hub 10. Then all the bolts 41, 42, 43 for fastening the fastening portions 31 of the fan blades 30 to the fixing seats 20 can be repositioned to make the fan set ready to operate.

The present invention allows the fan blades 30, fan hub 10 and dynamotor 60 to be assembled on the ground so is advantageous for easier and safer assembling process as compared with the prior art. Meantime, the assembly of the fan blades 30, fan hub 10 and dynamotor 60 can be installed at the top of the tower 61 through single hoist and installation, so the present invention, as compared to the repeated lifting operation required in the prior art, significantly reduces the time consumed by hoist. In addition, since the fan blades are retracted and temporarily fixed during hoist, the overall windage area can be reduced, thereby minimizing sway of the assembly in wind during hoist, and in turn improving safety of the installing operation.

The disclosed fan set is adaptive to a telescopic tower. It is well known that the telescopic tower helps to protect the wind power generator during installation and maintenance and in occasion of typhoons. By retracting the fan blades 30 of the fan set, the fan blades 30 can be well controlled from impacting the ground when the tower comes down and the tower is allowed to maximally lower for convenient assembly, maintenance or shelter from the undue windage.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A fan set for a wind power generator, the fan set comprising:
a fan hub;
a plurality of fixing seats fixed to the fan hub; and
a plurality of fan blades each having a fastening portion assembled to one said fixing seat,
wherein, each said fan blade has a concentrated position at which the fan blade is parallel to an axis of the fan hub and an expanded position at which the fan blade is perpendicular to the axis of the fan hub.

2. The fan set of claim 1, wherein the fixing seat has a base fixed to the fan hub, the base having a first lateral wall and a second lateral wall facing each other across the fixing seat, the first lateral wall and the second lateral wall being provided with a plurality of holes aligned to each other, the fastening portion of each said fan blade including a plurality of through holes passing through a minor length of the fastening portion, and the fastening portion being settled between the first lateral wall and the second lateral wall.

3. The fan set of claim 2, wherein a bolt pierces into the through holes of the fastening portion and corresponding said holes, so as to allow the fan blade to rotate against the bolt between the concentrated position and the expanded position.

4. The fan set of claim 2, wherein a plurality of bolts pierce into the holes and corresponding said through holes so as to fix the fan blade at the expanded position.

5. The fan set of claim 1, further comprising a plurality of retaining plates, each said retaining plate being removably assembled to a corresponding said fixing seat for retaining the fastening portion of the fan blade at the concentrated position from rotating toward the expanded position.

6. The fan set of claim 5, wherein each of the retaining plates is fixed to the first lateral wall or the second lateral wall by means of screws.

7. The fan set of claim 2, wherein the base has a third lateral wall connected between corresponding ends of the first lateral wall and the second lateral wall so that when the fan blade is at the concentrated position, the fastening portion of the fan blade is supported by the third lateral wall.

8. The fan set of claim 1, wherein a plurality of positioning recesses is provided at a front surface of the fan hub for receiving the bases of the fixing seats.
